(19) United States
(12) Patent Application Publication
(10) Pub. No.: US 2025/0350462 A1
(43) Pub. Date: Nov. 13, 2025

(54) METHODS AND APPARATUSES FOR PRESERVING PRIVACY OF ACCOUNT DATA IN BLOCKCHAIN

(71) Applicant: Ant Blockchain Technology (Shanghai) Co., Ltd., Shanghai (CN)

(72) Inventor: Zucheng Huang, Hangzhou (CN)

(73) Assignee: Ant Blockchain Technology (Shanghai) Co., Ltd., Shanghai (CN)

(21) Appl. No.: 19/272,791

(22) Filed: Jul. 17, 2025

(30) Foreign Application Priority Data
Apr. 28, 2023 (CN) 202310486673.1

(51) Int. Cl. H04L 9/32; G06F 21/60; G06F 21/62; H04L 9/00

(52) U.S. Cl. CPC H04L 9/321; G06F 21/602; G06F 21/6245; H04L 9/50

(57) ABSTRACT

This present disclosure provides methods and apparatuses for preserving privacy of account data in a blockchain. In an implementation, a method includes: determining, in response to receiving a target transaction, whether the target transaction involves a private account, and executing the target transaction in a trusted execution environment in response to determining that the target transaction involves a private account, wherein account data of the private account is encrypted and is stored in a target storage space outside the trusted execution environment.

### CROSS-REFERENCE TO RELATED APPLICATIONS

This application is a continuation of PCT Application No. PCT/CN2023/134867, filed on Nov. 28, 2023, which claims priority to Chinese Patent Application No. 202310486673.1, filed on Apr. 28, 2023, and each application is hereby incorporated by reference in its entirety.

### TECHNICAL FIELD

Embodiments of this specification pertain to the field of blockchain technologies, and in particular, relate to methods and apparatuses for preserving privacy of account data in a blockchain.

### BACKGROUND

Blockchain technologies are built on transport networks (such as peer-to-peer networks). Network nodes in the transport network use a chaining data structure to verify and store data, and use a distributed node consensus algorithm to generate and update data. Nodes in these blockchain networks sometimes need to be increased.

At present, the two biggest challenges of enterprise-level blockchain platform technologies are privacy and performance, which are often difficult to overcome at the same time. Most of the solutions are to gain privacy at costs of performance degradation, or pursue performance while sacrificing privacy. Common encryption technologies for alleviating privacy problems, such as homomorphic encryption and zero-knowledge proof, have high complexity and poor universality, and may cause serious performance degradation.

A trusted execution environment (TEE) is another solution to privacy problems. The TEE can act as a black box in hardware. The operating system layer cannot peep at code and data executed in the TEE, and only an interface predetermined in the code can operate on the code and the data. In terms of efficiency, due to the black box feature of the TEE, operation in the TEE uses plaintext data, and is not complex cryptographic operation in homomorphic encryption, so that there is no deterioration of efficiency in the computing process. Therefore, the combination with the TEE can greatly improve the security and privacy of the blockchain on the premise of less performance degradation. At present, the industry pays close attention to TEE solutions. Almost all major chipmakers and software alliances have their own TEE solutions, including software-based trusted platform module (TPM) and hardware-based Intel software guard extensions (SGX), ARM TrustZone, and AMD platform security processor (PSP).

### SUMMARY

An objective of this specification is to provide methods and apparatuses for preserving privacy of account data in a blockchain.

According to a first aspect of one or more embodiments of this specification, a method for preserving privacy of account data in a blockchain is proposed. The method includes the following: it is determined, in response to a received target transaction, whether the target transaction involves a private account; and the target transaction is executed in a trusted execution environment in response to that the target transaction involves a private account, where account data of the private account is encrypted and is stored in a target storage space outside the trusted execution environment.

According to a second aspect of one or more embodiments of this specification, an apparatus for preserving privacy of account data in a blockchain is proposed. The apparatus includes the following: a determining unit, configured to determine, in response to a received target transaction, whether the target transaction involves a private account; and a first execution unit, configured to execute the target transaction in a trusted execution environment in response to that the target transaction involves a private account, where account data of the private account is encrypted and is stored in a target storage space outside the trusted execution environment.

According to a third aspect of one or more embodiments of this specification, an electronic device is proposed, and includes a processor and a storage configured to store an instruction executable by the processor. The processor runs the executable instruction to implement the method according to the first aspect.

According to a fourth aspect of one or more embodiments of this specification, a computer-readable storage medium is proposed, and stores a computer instruction thereon. When the instruction is executed by a processor, steps of the method according to the first aspect are implemented.

In the embodiments of this specification, in one aspect, a transaction involving a private account in a blockchain is determined, so that each transaction involving a private account can be executed in a trusted execution environment, thereby ensuring privacy and security of account data of the private account. In another aspect, because a space of the trusted execution environment is limited, storing the account data of the private account in a target storage space outside the trusted execution environment can reduce occupation of the trusted execution environment, and improve utilization of the trusted execution environment. In addition, as the account data is encrypted in the trusted execution environment and then stored in the target storage space, the account data of the private account is presented in a plaintext form only in the trusted execution environment, and is in an encrypted state outside the trusted execution environment, thereby further ensuring the privacy and security of the account data of the private account.

### BRIEF DESCRIPTION OF DRAWINGS

To describe the technical solutions in the embodiments of this specification more clearly, the following briefly describes the accompanying drawings needed for describing the embodiments. Clearly, the accompanying drawings in the following description are merely some embodiments of this specification, and a person of ordinary skill in the art can still derive other drawings from these accompanying drawings without creative efforts.

FIG. 1 is a flowchart illustrating a method for preserving privacy of account data in a blockchain, according to some example embodiments;

FIG. 2 is a schematic diagram illustrating execution of a target transaction, according to some example embodiments;

FIG. 3 is a schematic structural diagram illustrating a device, according to some example embodiments; and

FIG. 4 is a block diagram illustrating an apparatus for preserving privacy of account data in a blockchain, according to some example embodiments.

### DESCRIPTION OF EMBODIMENTS

In order to enable persons skilled in the art to better understand the technical solutions in this specification, the technical solutions in embodiments of this specification would be clearly and completely described in combination with the attached drawings in the embodiments of this specification. Obviously, the described embodiments are only partial embodiments of this specification, not all embodiments. On the basis of the embodiments in this specification, all other embodiments obtained by persons having ordinary skill in the art without creative work shall fall within the scope of protection of this specification.

Blockchains are generally classified into three types: public blockchains, private blockchains, and consortium blockchains. In addition, there are combinations of a plurality of types, such as a combination of a private blockchain and a consortium blockchain, and a combination of a consortium blockchain and a public blockchain. The public blockchain has the highest degree of decentralization. Participants that join the public blockchain can read data records in the blockchain, participate in transactions, contend for ledger permissions of a new block, etc. In addition, each participant (namely node) can freely join and exit the network and perform related operations. The private blockchain is an opposite of the public blockchain. Write permission of the network is controlled by an organization or an institution, and data read permission is specified by the organization. In short, the private blockchain can be a weakly centralized system, and has few participating nodes with strict restrictions. This type of blockchain is more suitable for internal use of specific institutions. The consortium blockchain varies from the public blockchain to the private blockchain, and can implement “partial decentralization”. Each node in the consortium blockchain usually has a corresponding entity organization or institution. Participants are authorized to join the network and form a stakeholder alliance, and jointly maintain the operation of the blockchain.

All of the public blockchain, the private blockchain, and the consortium blockchain implement relevant functions and data interaction in a form of transactions, while each object participates in the transactions by using a corresponding account. Accounts can be classified into the following types: external accounts and contract accounts. An external account is usually controlled by an individual or an institution, and is used to generate and initiate a transaction. A contract account corresponds to a smart contract in a blockchain. The smart contract is a contract that can be triggered by a transaction in a blockchain of the public blockchain type, the private blockchain type or the consortium blockchain type. The smart contract is defined in a form of code.

After the smart contract is created, a contract account corresponding to the smart contract appears in the blockchain and has a specific address. Contract code and account storage are stored in the contract account. The behavior of the smart contract is controlled by the contract code, while the account storage of the smart contract preserves a state of the contract. In other words, the smart contract enables the generation of a virtual account in the blockchain that includes the contract code and account storage. When generating a transaction, an external account can invoke a smart contract by adding an address corresponding to the invoked smart contract to a “to” field of the transaction, so as to implement a relevant function by executing the code of the smart contract. The smart contract can be executed independently by each node in a blockchain network in a prescribed way, and all execution records and data are stored on the blockchain. Hence, when such transactions are completed, transaction vouchers that cannot be tampered with and cannot be lost are stored in the blockchain. Certainly, an external account does not have to invoke a smart contract when generating a transaction. For example, the transaction can be used only to implement a general transfer function.

FIG. 1 is a flowchart illustrating a method for preserving privacy of account data in a blockchain, according to some example embodiments. As shown in FIG. 1, the method includes at least the following steps: Step 102: Determine, in response to a received target transaction, whether the target transaction involves a private account.

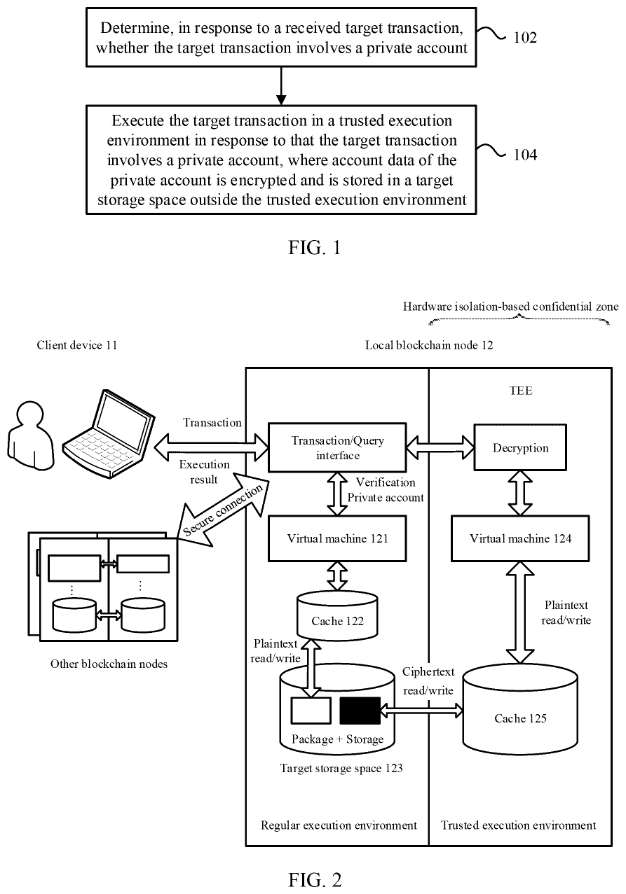

The target transaction can be an individual transaction, or can be one of multiple transactions included in the blockchain. A transaction in this specification can be used to implement relatively simple processing logic, such as transfer logic in related technologies. The transaction in this specification can be further used to implement relatively complex processing logic, which can be implemented here by using the smart contract above. As shown in FIG. 2, a local blockchain node 12 can run a virtual machine 121. The virtual machine 121 is a Turing-complete virtual machine, meaning that various complex logic can be implemented by using the virtual machine 121. Deploying and invoking smart contracts in the blockchain by users are implemented by the virtual machine 121. In fact, the virtual machine 121 directly runs virtual machine code (virtual machine bytecode, or “bytecode” for short). The smart contracts deployed in the blockchain can be in the form of bytecode.

The target transaction can be initiated by a client device and directly sent to a local blockchain node (the local blockchain node can be a blockchain node that the method shown in FIG. 1 is applied to). FIG. 2 is used as an example. The local blockchain node 12 includes a transaction/query interface, and the interface can be interconnected to a client device 11, so that the client device 11 can submit a transaction to the local blockchain node 12. Correspondingly, after the transaction is completed, the local blockchain node 12 can return an execution result of the transaction to the client device 11 by using the transaction/query interface. The execution result can include an execution success or an execution failure, and can further include detailed information such as a transaction log. This specification sets no limitation thereto.

The target transaction can alternatively be forwarded by another blockchain node in the blockchain to the local blockchain node. FIG. 2 is used as an example. The above-mentioned interface can be interconnected to another blockchain node, and the another blockchain node can forward the transaction to the local blockchain node 12. Similarly, other blockchain nodes can also be interconnected to the client device 11 through their own transaction/query interfaces to receive transactions submitted by the client device 11.

Account data of the private account is stored in a target storage space in a ciphertext form. In contrast, a regular account (i.e., non-private account) has its account data stored in the target storage space in a plaintext form. The private account can be an external account or a contract account.

The private account involved in the target transaction includes at least one of the following: a private account corresponding to an account address recorded in a field contained in the target transaction, a private account involved in a smart contract invoked by the target transaction, or a private account involved in a smart contract further directly or indirectly invoked by the smart contract invoked by the target transaction.

If an account address recorded in a “to” field of a transaction corresponds to a private account, the transaction involves a private account. If an account address recorded in a “to” field of a transaction corresponds to a smart contract, and the smart contract needs to access account data of a private account during execution, the transaction involves a private account. If an account address recorded in a “to” field of a transaction corresponds to smart contract A, smart contract A needs to access smart contract B during execution, and smart contract B needs to access account data of a private account during execution, the transaction also involves a private account. Analogously, if the target transaction directly or indirectly accesses account data of a private account during execution, the target transaction involves a private account. When the private account is an external account, the account data of the private account can be external-account data, including an account balance and an account status. When the private account is a contract account, the account data of the private account can be contract data, including contract code.

Step 104: Execute the target transaction in a trusted execution environment in response to that the target transaction involves a private account, where account data of the private account is encrypted and is stored in a target storage space outside the trusted execution environment.

The trusted execution environment (TEE) is a secure extension based on hardware of a CPU, and is totally isolated from the outside environment. The concept of TEE is first proposed by the Global Platform to securely isolate resources on mobile devices and provide trusted and secure execution environments parallel to the operating system for applications. Executing the target transaction within the trusted execution environment may involve running a virtual machine inside the trusted execution environment to carry out the processing logic recorded in the target transaction.

The target storage space can be any storage space outside the trusted execution environment, for example, a storage disk corresponding to another blockchain node in the blockchain, or another storage device. The account data of the private account is stored in the target storage space in the ciphertext form, and the account data of the regular account is stored in the target storage space in the plaintext form.

In the embodiments, in one aspect, a transaction involving a private account in a blockchain is determined, so that each transaction involving a private account can be executed in a trusted execution environment, thereby ensuring privacy and security of account data of the private account. In another aspect, because the account data of the private account is encrypted and is stored in a target storage space outside the trusted execution environment, the potential damage caused by account data leakage of the private account can be greatly reduced.

In some embodiments, the determining whether the target transaction involves a private account includes at least one of the following: executing the target transaction outside the trusted execution environment to determine account data involved in the target transaction; and determining that the target transaction involves a private account in response to that the determined account data includes encrypted account data; or performing pre-execution on the target transaction to obtain a pre-execution read-write set of the target transaction; and determining, based on the pre-execution read-write set of the target transaction, account data involved in the target transaction, and determining that the target transaction involves a private account in response to that the determined account data includes encrypted account data; or acquiring, for a target smart contract invoked by the target transaction, account data that is involved in the target smart contract and that is recorded in a contract account of the target smart contract; and determining that the target transaction involves a private account in response to that the determined account data includes encrypted account data; or determining that the target transaction involves a private account in response to that the target transaction is a privacy transaction.

Because the account data of the private account is stored in the ciphertext form, when the account data includes encrypted account data, it can be determined that the account is a private account.

In some embodiments, the target transaction is executed outside the trusted execution environment to determine the account data involved in the target transaction; and it is determined that the target transaction involves a private account in response to that the determined account data includes encrypted account data. As shown in FIG. 2, the local blockchain node 12 can be divided into a regular execution environment and a trusted execution environment. After the local blockchain node 12 acquires the target transaction, the target transaction can be executed by using the virtual machine 121 in the regular execution environment, so as to verify whether the target transaction involves a private account. During execution of the target transaction, account data of an account involved in the target transaction needs to be acquired. If the acquired account data does not include encrypted account data, the target transaction does not involve a private account, and the target transaction continues to be executed normally. If the acquired account data includes encrypted account data, the target transaction involves a private account. Because the virtual machine 121 in the regular execution environment cannot decrypt the encrypted account data, the virtual machine 121 stops executing the target transaction, and instead, a virtual machine 124 in the trusted execution environment executes the target transaction. In the embodiments, both transaction processing involving a non-private account in conventional technologies and transaction processing involving a private account can be considered, thereby supporting hybrid processing for transactions involving both private and non-private accounts on the entire blockchain network.

Pre-execution is performed on the target transaction to obtain the pre-execution read-write set of the target transaction; and the account data involved in the target transaction is determined based on the pre-execution read-write set of the target transaction, and it is determined that the target transaction involves a private account in response to that the determined account data includes encrypted account. The pre-execution read-write set of the target transaction includes a pre-execution read set and a pre-execution write set. The local blockchain node can determine, based on the pre-execution read-write set, the account data involved in the target transaction. For example, the pre-execution read-write set can record an account address of an account involved in the target transaction, and the target transaction can access the recorded account address to determine the account data involved in the target transaction. This embodiment determines whether a transaction involves a private account through its pre-execution read-write set. Since pre-execution consumes fewer resources and less time than full execution, this approach improves the efficiency of identifying private accounts.

For a target smart contract invoked by the target transaction, account data that is involved in the target smart contract and that is recorded in a contract account of the target smart contract is acquired; and it is determined that the target transaction involves a private account in response to that the determined account data includes encrypted account data. The target smart contract is a smart contract that is deployed in the blockchain and that is invoked by the target transaction. When the target smart contract is deployed in the blockchain, a read-write set is generated by association, and the read-write set is recorded in a contract account corresponding to the target smart contract, and is used to determine account data involved in the target smart contract. In the embodiments, it is determined, by using the account data recorded in the contract account of the target smart contract, whether the target transaction involves a private account. It can be determined whether the target account involves a private account, without having to perform the transaction, thereby improving determining efficiency of the private account.

It is determined that the target transaction involves a private account in response to that the target transaction is a privacy transaction. A transaction contains a transaction type field, and the field is used to define a transaction type of the corresponding transaction. A transaction whose transaction type field is set to a field value of “privacy transaction” is a privacy transaction, and a transaction whose transaction type field is set to a field value of “plaintext transaction” is a plaintext transaction. As shown in FIG. 2, a transaction submitted by the client device 11 (the transaction submitted by the client device 11 is used as an example) first enters the “transaction/query interface” in the regular execution environment for type identification, and an identified plaintext transaction is retained in the regular execution environment for processing, while an identified privacy transaction is transferred to the trusted execution environment for processing. In the embodiments, both processing for plaintext transactions in related technologies and processing for privacy transaction in the ciphertext form can be considered, thereby implementing hybrid processing for plaintext transactions and privacy transactions on the entire blockchain network.

In some embodiments, in response to that the target transaction involves the private account, the target transaction includes a transaction used to access the private account created or a transaction used to create the private account.

In the public blockchain, a user can freely create an external account. In this case, the user can mark the external account created by the user as a regular account or a private account. Each node in the blockchain network can individually pre-record type information of all external accounts. As such, when receiving the target transaction, the local blockchain node can read information about a generator account from a “from” field of the target transaction, and determine, based on the pre-recorded type information, whether the generator account is a regular account or a private account.

In the consortium blockchain or the private blockchain, a creation operation of an external account is limited. Other external accounts need to be created by a created external account instead of being created at will. The following limitation can be applied during creation: A regular account can create a regular account or a private account, whereas a private account can create only a private account; or a private account can create a regular account or a private account, whereas a regular account can create only a regular account. Similarly, in a blockchain network of the consortium blockchain or the private blockchain, each node should also pre-record type information of all external accounts. As such, when receiving the target transaction, the local blockchain node can read information about a generator account from a “from” field of the transaction, and determine, based on the pre-recorded type information, whether the generator account is a regular account or a private account.

In response to that the target transaction is a transaction used to access the private account created, the executing the target transaction in a trusted execution environment includes the following: reading the encrypted account data of the private account to the trusted execution environment for decryption processing, to obtain plaintext account data of the private account; and executing the target transaction in the trusted execution environment based on the obtained plaintext account data, and encrypting obtained updated plaintext account data for storage in the target storage space to update the encrypted account data.

If the account data of the private account is encrypted in a symmetric encryption way and is stored in the target storage space, correspondingly, the local blockchain node can decrypt the encrypted account data of the private account by using a symmetric key of a symmetric encryption algorithm. Encryption algorithms for symmetric encryption are, e.g., the DES algorithm, the 3DES algorithm, the TDEA algorithm, the Blowfish algorithm, the RC5 algorithm, and the IDEA algorithm. The symmetric key of the symmetric encryption algorithm can be, e.g., generated by a generator of the private account, determined by the client device by negotiation with the local blockchain node, or sent by a key management server.

If the account data of the private account is encrypted in an asymmetric encryption way, i.e., by using a public key of an asymmetric encryption algorithm, correspondingly, the local blockchain node can decrypt the encrypted account data by using a private key of the asymmetric encryption algorithm. Encryption algorithms for asymmetric encryption are, e.g., the RSA algorithm, the ElGamal algorithm, the Knapsack algorithm, the Rabin algorithm, the D-H algorithm, and the elliptic curve cryptography (ECC) algorithm. The keys for the asymmetric encryption algorithm can be, e.g., a pair of public key and private key generated by the local blockchain node. The public key is sent to the client device in advance, so that the client device can use the public key to encrypt the account data.

The keys for the asymmetric encryption algorithm can alternatively be generated by a key management server. Through remote attestation, the key management server sends the private key to the local blockchain node, and specifically to an enclave of the local blockchain node. The first blockchain node can include multiple enclaves, and the above-mentioned private key can be transferred into a security enclave among these enclaves. For example, the security enclave can be a quoting enclave (QE) rather than an application enclave (AE). The public key for asymmetric encryption can be sent by the key management server to the client device. Therefore, the client device can encrypt the account data by using the public key. Correspondingly, the local blockchain node can decrypt the encrypted account data by using the private key, to obtain the plaintext account data of the private account.

The client device can alternatively use a combination of a symmetric encryption method and an asymmetric encryption method. For example, the client device encrypts the account data by using a symmetric encryption algorithm, that is, encrypts the account data by using the symmetric key of the symmetric encryption algorithm, and uses an asymmetric encryption algorithm to encrypt the symmetric key used in the symmetric encryption algorithm. Generally, a public key of the asymmetric encryption algorithm is used to encrypt the symmetric key used in the symmetric encryption algorithm. As such, after receiving the encrypted account data, the local blockchain node can first use the private key of the asymmetric encryption algorithm to perform decryption to obtain the symmetric key of the symmetric encryption algorithm, and then use the symmetric key of the symmetric encryption algorithm to perform decryption to obtain the plaintext account data.

As shown in FIG. 2, after determining that the target transaction involves the private account, the virtual machine 121 can send the target transaction to the trusted execution environment, read the encrypted account data of the private account to the trusted execution environment for decryption processing, to obtain plaintext account data of the private account, and execute the target transaction based on the obtained plaintext account data and the virtual machine 124 in the trusted execution environment. The local blockchain node can execute write cache function code in the trusted execution environment, so as to store the plaintext execution result in a write cache in the trusted execution environment. For example, the write cache can correspond to a “cache” shown in FIG. 2. Further, the local blockchain node encrypts data in the write cache and outputs the data from the trusted execution environment, so as to store the data in a target storage space 123. The write cache function code can be stored in the trusted execution environment in the plaintext form, and the cache function code in the plaintext form can be directly executed in the trusted execution environment. Or, the write cache function code can be stored outside the trusted execution environment in the ciphertext form, for example, stored in the target storage space 123 (for example, for “package +storage” shown in FIG. 2, “package” indicates that the local blockchain node packages a transaction into a block outside the trusted execution environment). The write cache function code in the ciphertext form can be read into the trusted execution environment and decrypted into plaintext code in the trusted execution environment, and the plaintext code can be executed.

The write cache is a “cache” mechanism provided to avoid “impact” on the target storage space 123 when data are written to the target storage space 123. For example, the write cache can be implemented by using a buffer. Certainly, the write cache can also be implemented by using a cache. This specification sets no limitation thereto. In fact, the trusted execution environment is an isolated security environment, and the target storage space 123 is located outside the trusted execution environment, so that data in the cache can be written to the target storage space 123 in batches by using a write cache mechanism, thereby reducing the number of times of interaction between the trusted execution environment and the target storage space 123, and improving data storage efficiency. In addition, during continuous execution of pieces of plaintext transaction content in the trusted execution environment, generated data (for example, a value of a contract status) may need to be retrieved. If the data that needs to be retrieved is just located in the write cache, the data can be directly read from the write cache. As such, interaction with the target storage space 123 can be reduced, and a process of decrypting the data read from the target storage space 123 is omitted, thereby improving data processing efficiency in the trusted execution environment.

Certainly, the write cache can also be established outside the trusted execution environment. For example, the local blockchain node can execute the write cache function code outside the trusted execution environment, so as to store the ciphertext execution result in the write cache outside the trusted execution environment, and further store the data in the write cache into the target storage space 123. This specification sets no limitation thereto.

In some embodiments, in response to that the target transaction is a transaction used to create the private account, the executing the target transaction in a trusted execution environment includes the following: creating the private account in the trusted execution environment based on account creation-related information included in the target transaction, and storing account data of the private account in the target storage space after encryption.

Compared with a transaction that creates a regular account, an account created by a transaction that creates a private account corresponds to a type of private account. A method for determining a transaction type can include the following: adding a transaction type field to a transaction, where a transaction for creating a regular account corresponds to a field value of “create normal”, and a transaction for creating a private account corresponds to a field value of “create private”. The blockchain node can determine a transaction type by identifying the field value of the transaction type field, and further determine a type of an account to be created. Or, the local blockchain node can include, in a transaction, a key to be used to encrypt account data, and add processing logic of “using the key to encrypt the account data in response to determining that a transaction includes the key” to blockchain code of the local blockchain node.

In the embodiments, a private account can be created in the trusted execution environment, so that plaintext account data in a creation process is not leaked, and account data of the created private account can be encrypted and be stored in the target storage space, thereby reducing a risk of privacy exposure following leakage of the encrypted account data.

In some embodiments, the target transaction is executed outside the trusted execution environment in response to that the target transaction does not involve the private account.

As shown in FIG. 2, when the target transaction does not involve the private account, the local blockchain node executes the target transaction in the virtual machine 121 in the regular execution environment, and stores an execution result in the plaintext form in the target storage space 123. In the embodiments, both transaction processing not involving a private account in related technologies and transaction processing involving a private account can be considered, thereby implementing hybrid processing for transactions involving or not involving a private account on the entire blockchain network.

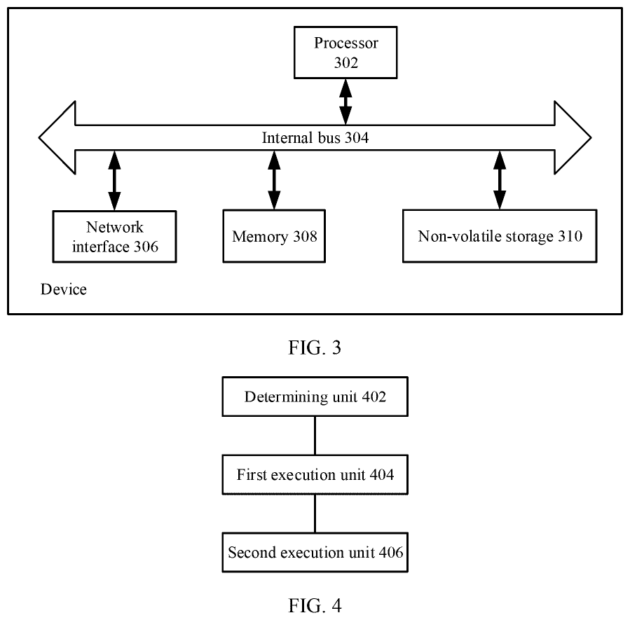

FIG. 3 is a schematic structural diagram illustrating a device, according to some example embodiments. Referring to FIG. 3, in terms of hardware, the device includes a processor 302, an internal bus 304, a network interface 306, a memory 308, and a non-volatile memory 310, and certainly may further include hardware needed for another function. One or more embodiments of this specification can be implemented in a software-based way. For example, the processor 302 reads a corresponding computer program from the non-volatile memory 310 into the memory 308, and then runs the computer program. Certainly, in addition to a software implementation, one or more embodiments of this specification do not exclude another implementation, for example, a logic device or a combination of hardware and software. That is, an execution body of the following processing procedure is not limited to each logical unit, and can be hardware or a logic device.

FIG. 4 is a block diagram illustrating an apparatus for preserving privacy of account data in a blockchain, according to some example embodiments. The apparatus can be applied to the device shown in FIG. 4, so as to implement the technical solutions of this specification. The apparatus includes the following: a determining unit 402, configured to determine, in response to a received target transaction, whether the target transaction involves a private account; and a first execution unit 404, configured to execute the target transaction in a trusted execution environment in response to that the target transaction involves a private account, where account data of the private account is encrypted and is stored in a target storage space outside the trusted execution environment.

Optionally, the determining unit 402 is specifically configured to perform at least one of the following: executing the target transaction outside the trusted execution environment to determine account data involved in the target transaction; and determining that the target transaction involves a private account in response to that the determined account data includes encrypted account data; or performing pre-execution on the target transaction to obtain a pre-execution read-write set of the target transaction; and determining, based on the pre-execution read-write set of the target transaction, account data involved in the target transaction, and determining that the target transaction involves a private account in response to that the determined account data includes encrypted account data; or acquiring, for a target smart contract invoked by the target transaction, account data that is involved in the target smart contract and that is recorded in a contract account of the target smart contract; and determining that the target transaction involves a private account in response to that the determined account data includes encrypted account data; or determining that the target transaction involves a private account in response to that the target transaction is a privacy transaction.

Optionally, in response to that the target transaction involves the private account, the target transaction includes a transaction used to access the private account created or a transaction used to create the private account.

Optionally, in response to that the target transaction is a transaction used to access the private account created, the first execution unit 404 is specifically configured to read the encrypted account data of the private account to the trusted execution environment for decryption processing, to obtain plaintext account data of the private account; and execute the target transaction in the trusted execution environment based on the obtained plaintext account data, and encrypt obtained updated plaintext account data for storage in the target storage space to update the encrypted account data.

Optionally, the private account involved in the target transaction includes at least one of the following: a private account corresponding to an account address recorded in a field contained in the target transaction, a private account involved in a smart contract invoked by the target transaction, or a private account involved in a smart contract further directly or indirectly invoked by the smart contract invoked by the target transaction.

Optionally, in response to that the target transaction is a transaction used to create the private account, the first execution unit 404 is specifically configured to create the private account in the trusted execution environment based on account creation-related information included in the target transaction, and store account data of the private account in the target storage space after encryption.

Optionally, the apparatus further includes a second execution unit 406, configured to execute the target transaction outside the trusted execution environment in response to that the target transaction does not involve the private account.

In the 1990s, whether a technical improvement is a hardware improvement (for example, an improvement to a circuit structure, such as a diode, a transistor, or a switch) or a software improvement (an improvement to a method procedure) can be clearly distinguished. However, as technologies develop, current improvements to many method procedures can be considered as direct improvements to hardware circuit structures. Almost all designers get the corresponding hardware circuit structure by programming the improved method flow into the hardware circuit. Hence, it cannot say that an improvement of a method flow cannot be implemented using a hardware entity module. For example, a Programmable Logic Device (PLD), such as a Field Programmable Gate Array (FPGA), is such an integrated circuit whose logic functions are determined by the user programming the device. By the designer's own programming to “integrate” a digital system on a PLD, without asking the chip manufacturer to design and produce a special integrated circuit chip. Moreover, now, instead of manually making an integrated circuit chip, this programming is mostly executed with “logic compiler” software, which is similar to a software compiler used when the program is developed, and the original code before it is compiled also has to be written in a specific programming language, which is referred to as Hardware Description Language (HDL), and there is not just one HDL, but many HDLs, such as Advanced Boolean Expression Language (ABEL), Altera Hardware Description Language (AHDL), Confluence, Cornell University Programming Language (CUPL), HDCal, Java Hardware Description Language (JHDL), Lava, Lola, MyHDL, PALASM, and Ruby Hardware Description Language (RHDL). Very-High-Speed Integrated Circuit Hardware Description Language (VHDL) and Verilog are the most commonly used currently. Persons skilled in the art should also know that only by using the above-mentioned hardware description languages to perform a little logic programming on the method flow and programming same into the integrated circuit, the hardware circuit for realizing the logic method flow can be easily obtained.

The controller can be implemented in any appropriate way, for example, the controller can be in the form of, for example, a microprocessor or processor and a computer readable medium, logic gates, switches, an Application Specific Integrated Circuit (ASIC), programmable logic controllers, and embedded microcontrollers, which store the computer readable program code (for example, software or firmware) that can be executed by the (micro) processor. Examples of the controller include, but are not limited to, the following microcontrollers: ARC 625D, Atmel AT91SAM, Microchip PIC18F26K20, and Silicone Labs C8051F320. The memory controllers can also be implemented as part of the memory control logic. It is also known to persons skilled in the art that, in addition to implementing the controller in a purely computer-readable program code manner, it is entirely possible to perform the same functions of the controller in the form of logic gates, switches, ASIC, programmable logic controllers, embedded microcontrollers and the like by logic programming the method steps. Hence, this controller can be considered to be a hardware component, while an apparatus included therein for implementing various functions can also be considered as the structure in the hardware component. Or the apparatus for implementing various functions can even be considered as both a software module for implementing a method and the structure in the hardware component.

The system, apparatus, module, or unit stated in the embodiments above can specifically be implemented using a computer chip or entity, or can be implemented by a product having a certain function. A typical implementing device is a server system. Certainly, this specification does not exclude that with development of future computer technologies, a computer that implements a function in the above-mentioned embodiments can be, for example, a personal computer, a laptop computer, a vehicle-mounted man-machine interaction device, a cellular phone, a camera phone, a smartphone, a personal digital assistant, a media player, a navigation device, an e-mail device, a game console, a tablet computer, a wearable device, or a combination of any of these devices.

Although one or more embodiments of this specification provide method operating steps as described in some embodiments or flowcharts, more or fewer operating steps can be included on the basis of conventional or non-creative means. The sequence of steps enumerated in the embodiments is only one way among multiple step execution sequences and does not represent a unique sequence of execution. When executed in an actual apparatus or end product, it can be executed sequentially or in parallel in accordance with the method sequence shown in the embodiments or the accompanying drawings (for example, a parallel processor or multithreaded processing environment, or even a distributed data processing environment). The term “include”, “comprise”, or any other variation thereof is intended to cover non-exclusive inclusion, such that a process, method, product, or device including a set of elements includes not only those elements but also other elements not explicitly listed, or elements inherent to such a process, method, product, or device. Without further limitations, it does not preclude the existence of additional identical or equivalent elements in the process, method, product or device including such elements. For example, if the words first, second, and the like are used for indicating names, they do not indicate any particular order.

For the convenience of description, the above-mentioned apparatuses are divided into various modules according to functions for respective descriptions. Of course, when implementing one or more of this specification, functions of various modules can be realized in the same or more software and/or hardware, and the modules that achieve the same function can also be realized by a combination of multiple sub-modules or sub-units. The apparatus embodiments described above are only schematic, for example, the division of units is only a logical function division; in actual implementation, there can be other ways of division; for example, multiple units or assemblies can be combined or can be integrated into another system, or some features can be omitted, or not performed. On the other hand, the coupling or direct coupling or communicative connection between each other shown or discussed can be indirect coupling or communicative connection through some interfaces, apparatuses or units, and can be in electrical, mechanical or other forms.

This specification is described with reference to the flowchart and/or block charts of methods, apparatuses (systems), and computer program products according to the embodiments of this specification. It should be understood that each process and/or box in a flowchart and/or block chart, and combinations of processes and/or boxes in the flowchart and/or block chart, can be implemented by computer program instructions. These computer program instructions can be provided to processors of a general-purpose computer, a special purpose computer, an embedded processor, or other programmable data processing devices, to produce a machine, so that the instructions executed by the processors of the computer or other programmable data processing devices generate an apparatus for implementing functions specified in one or more processes of a flowchart and/or one or more boxes of a block chart.

These computer program instructions can also be stored in a computer-readable memory that can guide a computer or another programmable data processing device to operate in a particular manner, such that the instructions stored in the computer readable memory produce an article of manufacture including an instruction apparatus, and the instruction apparatus implements the functions specified in the one or more processes of the flowchart and/or the one or more boxes of the block chart.

These computer program instructions can also be loaded to a computer or another programmable data processing device, so that a series of operating steps are executed on the computer or another programmable data processing device, to generate the processing implemented by the computer, and therefore, the instructions executed on the computer or another programmable data processing device provide steps of implementing the functions specified in the one or more processes of the flowchart and/or the one or more boxes of the block chart.

In a typical configuration, a computing device includes one or more processors (CPU), an input/output interface, a network interface, and a memory.

The memory may include a non-persistent storage, a random access memory (RAM), and/or a non-volatile memory in a computer-readable medium, for example, a read-only memory (ROM) or a flash read-only memory (flash RAM). The memory is an example of the computer-readable medium.

The computer-readable medium includes persistent, non-persistent, movable, and non-movable media that can store information by using any method or technology. The information can be computer-readable instructions, a data structure, a program module, or other data. Examples of the computer storage medium include but are not limited to a phase change random access memory (PRAM), a static random access memory (SRAM), a dynamic random access memory (DRAM), another type of random access memory (RAM), a read-only memory (ROM), an electrically erasable programmable read-only memory (EEPROM), a flash memory or another memory technology, a compact disc read-only memory (CD-ROM), a digital versatile disc (DVD) or another optical storage, a cassette magnetic tape, a magnetic tape/magnetic disk storage, a graphene storage, another magnetic storage device, or any other non-transmission medium. The computer storage medium can be configured to store information that can be accessed by a computing device. As specified in this specification, the computer-readable medium does not include transitory computer-readable media (transitory media), such as a modulated data signal and carrier.

A person skilled in the art should understand that one or more embodiments of this specification can be provided as methods, systems, or computer program products. Hence, the one or more embodiments of this specification can adopt forms of fully hardware embodiments, fully software embodiments, or embodiments combining software and hardware aspects. Moreover, the one or more embodiments of this specification can use the form of a computer program product implemented on one or more computer available storage media (including, but not limited to, disk storage, CD-ROM, optical memory, etc.), wherein the computer available program code is included.

The one or more embodiments of this specification can be described in a common context of a computer executable instruction executed by a computer, for example, a program module. Generally, the program module includes routines, programs, objects, assemblies, data structures, and so on that perform specific tasks or implement specific abstract data types. The one or more embodiments of this specification can also be practiced in a distributed computing environment where tasks are performed by remote processing devices that are connected through a communication network. In the distributed computing environment, the program module can be located in local and remote computer storage media, including the storage devices.

Each embodiment in this specification is described in a progressive manner, same and similar parts between each embodiment can be referred to by one other, and each embodiment focuses on differences from other embodiments. In particular, for system embodiments, because they are basically similar to method embodiments, the description is relatively simple, and the relevant features can be seen in the partial description of the method embodiments. In the description of this specification, references to term “an embodiment”, “some embodiments”, “examples”, “specific examples”, or “some examples” mean that specific features, structures, materials, or characteristics described in conjunction with this embodiment or example are included in at least one embodiment or example of this specification. In this specification, it is unnecessary for the explanatory representation of the above-mentioned terms to refer to the same embodiment or example. Moreover, the specific features, structures, materials, or characteristics described can be combined in any one or more embodiments or examples in a suitable manner. In addition, without contradicting each other, persons skilled in the art can combine and integrate different embodiments or examples described in this specification and features of the different embodiments or examples.

The above-mentioned descriptions are merely one or more embodiments of this specification, and are not intended to limit the one or more embodiments of this specification. A person skilled in the art can make various changes and variations to one or more embodiments of this specification. Any modification, equivalent substitution, improvement, etc. made within the spirit and principle of this specification shall all be included in the scopes of the claims.

1. A method for preserving privacy of account data in a blockchain, comprising:
determining, in response to receiving a target transaction, whether the target transaction involves a private account; and
executing the target transaction in a trusted execution environment in response to determining that the target transaction involves a private account, wherein account data of the private account is encrypted and is stored in a target storage space outside the trusted execution environment.

2. The method according to claim 1, wherein the determining whether the target transaction involves a private account comprises one of:
executing the target transaction outside the trusted execution environment to determine account data involved in the target transaction, and determining that the target transaction involves a private account in response to determining that the determined account data comprises encrypted account data;
performing pre-execution on the target transaction to obtain a pre-execution read-write set of the target transaction, determining, based on the pre-execution read-write set of the target transaction, account data involved in the target transaction, and determining that the target transaction involves a private account in response to determining that the determined account data comprises encrypted account data;
obtaining, for a target smart contract invoked by the target transaction, account data involved in the target smart contract and recorded in a contract account of the target smart contract, and determining that the target transaction involves a private account in response to determining that the determined account data comprises encrypted account data; or
determining that the target transaction involves a private account in response to determining that the target transaction is a privacy transaction.

3. The method according to claim 1, wherein the target transaction involves the private account, and wherein the target transaction comprises a transaction for accessing the private account created or creating the private account.

4. The method according to claim 3, wherein the target transaction is a transaction for accessing the private account created, and wherein the executing the target transaction in a trusted execution environment comprises:
reading the encrypted account data of the private account to the trusted execution environment for decryption processing, to obtain plaintext account data of the private account;
executing the target transaction in the trusted execution environment based on the obtained plaintext account data; and
encrypting the obtained plaintext account data for storage in the target storage space to update the encrypted account data.

5. The method according to claim 1, wherein the private account involved in the target transaction comprises at least one of: a private account corresponding to an account address recorded in a field contained in the target transaction, a private account involved in a smart contract invoked by the target transaction, or a private account invoked by the smart contract that is invoked by the target transaction.

6. The method according to claim 3, wherein the target transaction is a transaction for creating the private account, wherein the executing the target transaction in a trusted execution environment comprises:
creating the private account in the trusted execution environment based on account creation-related information comprised in the target transaction; and
storing account data of the private account in the target storage space after encryption.

7. The method according to claim 1, further comprising:
executing the target transaction outside the trusted execution environment in response to determining that the target transaction does not involve the private account.

8. An apparatus for preserving privacy of account data in a blockchain, comprising:
at least one processor; and
one or more memories coupled to the at least one processor and storing programming instructions for execution by the at least one processor to perform operations comprising:
determining, in response to receiving a target transaction, whether the target transaction involves a private account; and
executing the target transaction in a trusted execution environment in response to determining that the target transaction involves a private account, wherein account data of the private account is encrypted and is stored in a target storage space outside the trusted execution environment.

9. The apparatus according to claim 8, wherein the determining whether the target transaction involves a private account comprises one of:
executing the target transaction outside the trusted execution environment to determine account data involved in the target transaction, and determining that the target transaction involves a private account in response to determining that the determined account data comprises encrypted account data;
performing pre-execution on the target transaction to obtain a pre-execution read-write set of the target transaction, determining, based on the pre-execution read-write set of the target transaction, account data involved in the target transaction, and determining that the target transaction involves a private account in response to determining that the determined account data comprises encrypted account data;
obtaining, for a target smart contract invoked by the target transaction, account data involved in the target smart contract and recorded in a contract account of the target smart contract, and determining that the target transaction involves a private account in response to determining that the determined account data comprises encrypted account data; or
determining that the target transaction involves a private account in response to determining that the target transaction is a privacy transaction.

10. The apparatus according to claim 8, wherein the target transaction involves the private account, and wherein the target transaction comprises a transaction for accessing the private account created or creating the private account.

11. The apparatus according to claim 10, wherein the target transaction is a transaction for accessing the private account created, and wherein the executing the target transaction in a trusted execution environment comprises:
reading the encrypted account data of the private account to the trusted execution environment for decryption processing, to obtain plaintext account data of the private account;
executing the target transaction in the trusted execution environment based on the obtained plaintext account data; and
encrypting the obtained plaintext account data for storage in the target storage space to update the encrypted account data.

12. The apparatus according to claim 8, wherein the private account involved in the target transaction comprises at least one of: a private account corresponding to an account address recorded in a field contained in the target transaction, a private account involved in a smart contract invoked by the target transaction, or a private account invoked by the smart contract that is invoked by the target transaction.

13. The apparatus according to claim 10, wherein the target transaction is a transaction for creating the private account, wherein the executing the target transaction in a trusted execution environment comprises:
creating the private account in the trusted execution environment based on account creation-related information comprised in the target transaction; and
storing account data of the private account in the target storage space after encryption.

14. The apparatus according to claim 8, further comprising:
executing the target transaction outside the trusted execution environment in response to determining that the target transaction does not involve the private account.

15. A non-transitory, computer-readable medium storing one or more instructions executable by at least one processor to perform operations comprising:
determining, in response to receiving a target transaction, whether the target transaction involves a private account; and
executing the target transaction in a trusted execution environment in response to determining that the target transaction involves a private account, wherein account data of the private account is encrypted and is stored in a target storage space outside the trusted execution environment.

16. The non-transitory, computer-readable medium according to claim 15, wherein the determining whether the target transaction involves a private account comprises one of:
executing the target transaction outside the trusted execution environment to determine account data involved in the target transaction, and determining that the target transaction involves a private account in response to determining that the determined account data comprises encrypted account data;
performing pre-execution on the target transaction to obtain a pre-execution read-write set of the target transaction, determining, based on the pre-execution read-write set of the target transaction, account data involved in the target transaction, and determining that the target transaction involves a private account in response to determining that the determined account data comprises encrypted account data;
obtaining, for a target smart contract invoked by the target transaction, account data involved in the target smart contract and recorded in a contract account of the target smart contract, and determining that the target transaction involves a private account in response to determining that the determined account data comprises encrypted account data; or
determining that the target transaction involves a private account in response to determining that the target transaction is a privacy transaction.

17. The non-transitory, computer-readable medium according to claim 15, wherein the target transaction involves the private account, and wherein the target transaction comprises a transaction for accessing the private account created or creating the private account.

18. The non-transitory, computer-readable medium according to claim 17, wherein the target transaction is a transaction for accessing the private account created, and wherein the executing the target transaction in a trusted execution environment comprises:
reading the encrypted account data of the private account to the trusted execution environment for decryption processing, to obtain plaintext account data of the private account;
executing the target transaction in the trusted execution environment based on the obtained plaintext account data; and
encrypting the obtained plaintext account data for storage in the target storage space to update the encrypted account data.

19. The non-transitory, computer-readable medium according to claim 15, wherein the private account involved in the target transaction comprises at least one of: a private account corresponding to an account address recorded in a field contained in the target transaction, a private account involved in a smart contract invoked by the target transaction, or a private account invoked by the smart contract that is invoked by the target transaction.

20. The non-transitory, computer-readable medium according to claim 17, wherein the target transaction is a transaction for creating the private account, wherein the executing the target transaction in a trusted execution environment comprises:
creating the private account in the trusted execution environment based on account creation-related information comprised in the target transaction; and
storing account data of the private account in the target storage space after encryption.
